(19) United States
(12) Patent Application Publication
(10) Pub. No.: US 2026/0164096 A1
(43) Pub. Date: Jun. 11, 2026

(54) METHOD AND APPARATUS FOR GENERATING VIDEOS, DEVICE AND PRODUCT

(71) Applicants: Beijing Zitiao Network Technology Co., Ltd., Beijing (CN); Lemon Inc., Grand Cayman (KY)

(72) Inventors: Zhongping MA, Beijing (CN); Jinlin WEI, Beijing (CN); Shiwei LI, Singapore (SG)

(21) Appl. No.: 19/331,996

(22) Filed: Sep. 17, 2025

(30) Foreign Application Priority Data
Dec. 6, 2024 (CN) 202411794525.7

(51) Int. Cl. H04N 21/81; H04N 21/439; H04N 21/845

(52) U.S. Cl. CPC H04N 21/816; H04N 21/4394; H04N 21/8113; H04N 21/8456

(57) ABSTRACT

The present disclosure relates to method and apparatus for generating a video and a product. The method comprises determining beat point information of an audio associated with a first video. The method also comprises adjusting, based on the beat point information, a duration of at least one video clip among a plurality of video clips included in the first video. The method further comprises generating, based on a plurality of adjusted video clips and the audio, a second video, the second video matching the beat point information of the audio.

### CROSS-REFERENCE TO RELATED APPLICATION(S)

This application claims priority to Chinese Application No. 202411794525.7, filed on Dec. 6, 2024, the disclosure of which is incorporated herein by reference in its entirety.

### FIELD

The present disclosure relates to computer field, and more specifically to method and apparatus for generating videos, and a product.

### BACKGROUND

Videos synced with music beat, as a creative presentation of video, create a strong sense of rhythm and visual impact by synchronizing the switching of video images with the beat of music, thereby enhancing the view ability and rhythm of the video. This form of video requires that the switching point of the video content must correspond closely to the beat of the music in order to achieve the best audio-visual effect.

At present, users may input audio and video files on their own and manually adjust the switching points of the video images according to their own creativity and demands, so as to align with the beat points of the music. Meanwhile, to facilitate the users to edit the videos synced with music beats, many editing software provide a function for automatic beat sync of the videos. The editing software provided with automatic beat sync function can detect music beats and automatically adjusts switching points of the video images, so as to synchronize with the music beats.

### SUMMARY

In a first aspect of the embodiments of the present disclosure, there is provided a method for generating a video. The method comprises determining beat point information of an audio associated with a first video. The method also comprises adjusting, based on the beat point information, a duration of at least one video clip in a plurality of video clips included among the first video. The method further comprises generating, based on a plurality of adjusted video clips and the audio, a second video, the second video matching the beat point information of the audio.

In a second aspect of the embodiments of the present disclosure, there is provided an apparatus for generating a video. The apparatus comprises a module for determining beat point information configured to determine beat point information of an audio associated with a first video. The apparatus also comprises a module for adjusting video clip configured to adjust, based on the beat point information, a duration of at least one video clip in a plurality of video clips included among the first video. The apparatus further comprises a module for generating video configured to generate, based on a plurality of adjusted video clips and the audio, a second video, the second video matching the beat point information of the audio.

In a third aspect of the embodiments of the present disclosure, there is provided an electronic device. The electronic device comprises one or more processors; and a memory for storing one or more programs, wherein the one or more programs, when executed by one or more processors, cause the one or more processors to implement a method for generating a video. The method comprises determining beat point information of an audio associated with a first video. The method also comprises adjusting, based on the beat point information, a duration of at least one video clip in a plurality of video clips included among the first video. The method further comprises generating, based on a plurality of adjusted video clips and the audio, a second video, the second video matching the beat point information of the audio.

In a fourth aspect of the embodiments of the present disclosure, there is provided a computer program product. The computer program product is tangibly stored on a non-transitory computer-readable medium and comprises machine-executable instructions, wherein the machine-executable instructions, when executed, cause a machine to implement a method for generating a video. The method comprises determining beat point information of an audio associated with a first video. The method also comprises adjusting, based on the beat point information, a duration of at least one video clip in a plurality of video clips included among the first video. The method further comprises generating, based on a plurality of adjusted video clips and the audio, a second video, the second video matching the beat point information of the audio.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features of the present disclosure will be understood more easily through the following description.

### BRIEF DESCRIPTION OF THE DRAWINGS

With reference to the drawings and the following detailed description, the above and other features, advantages and aspects of various embodiments of the present disclosure will become more apparent. In the drawings, same or similar reference signs indicate same or similar elements, wherein:

FIG. 1 illustrates a schematic diagram of an example environment 100 in which a plurality of embodiments of the present disclosure may be implemented;

FIG. 2 illustrates a flowchart of a method for generating a video in accordance with some embodiments of the present disclosure;

FIG. 3A illustrates a schematic diagram of the beat point information of the audio in accordance with some embodiments of the present disclosure;

FIG. 3B illustrates a schematic diagram of editing audio in accordance with some embodiments of the present disclosure;

FIG. 3C illustrates a schematic diagram of generalized audio parameters in accordance with some embodiments of the present disclosure;

FIG. 3D illustrates a schematic diagram of the beat point data in the audio in accordance with some embodiments of the present disclosure;

FIG. 4A illustrates a schematic diagram of generating a video clip through video editing in accordance with some embodiments of the present disclosure;

FIG. 4B illustrates a schematic diagram of parameters of the video clip in accordance with some embodiments of the present disclosure;

FIG. 5 illustrates a flowchart of a beat sync algorithm in accordance with some embodiments of the present disclosure;

FIG. 6A illustrates a flowchart of a method for determining an expected effective duration of each video clip in accordance with some embodiments of the present disclosure;

FIG. 6B illustrates an effect picture of determining an expected effective duration of each video clip in accordance with some embodiments of the present disclosure;

FIG. 7A illustrates a flowchart of a method for adjusting the duration of the video clip in accordance with some embodiments of the present disclosure;

FIG. 7B illustrates a schematic diagram of adjusting the ending overlapping transition and/or the starting overlapping transition in accordance with some embodiments of the present disclosure;

FIG. 8 illustrates an effect graph of generating a video in accordance with some embodiments of the present disclosure;

FIG. 9 illustrates a block diagram of an apparatus for generating a video in accordance with some embodiments of the present disclosure; and

FIG. 10 illustrates a block diagram of a device capable of implementing a plurality of embodiments of the present disclosure.

### DETAILED DESCRIPTION OF EMBODIMENTS

It is to be appreciated that all user-related data involved in the technical solution should be obtained and used after user authorization. This means that if the personal information of the users is to be used in the technical solution, explicit consent and authorization shall be given by the users before obtaining the personal information; otherwise, related data would not be collected and used. It also should be understood that in implementing the technical solution, one shall strictly follow relevant laws and regulations during collection, usage and storage of the data and take necessary techniques and measures to guarantee user data safety and ensure safe usage of data.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “this embodiment” is to be read as “at least one embodiment.” The terms “first”, “second” and so on can refer to same or different objects. The following text also may include other explicit and implicit definitions.

As stated above, to facilitate users to edit videos synced with music beat, many editing software programs provide a function for automatic beat sync of the videos. In the related art, although the automatic beat sync function of the editing software simplifies the creation process to a certain extent, the results are significantly confined by templates. The function, when used by advanced users, can hardly meet their individualized needs due to restrictions over the number and the style of the templates, and also has deficiencies in deep editing. Users can hardly adjust the music rhythms finely and they also fail to set the highly customized beats in accordance with creativity demands. This further limits diversity and depth of the creation.

In addition, obvious problems may occur when the related automatic beat sync function is used in combination with other editing functions. When the users try to apply speed change and overlapping transition functions after the automatic beat sync, the already synced rhythms may be damaged and the existing timeline is disrupted. Likewise, if these functions are applied before the automatic beat sync, the software would clear the editing acts already made by the users, such as speed change and transition etc., to ensure the beat sync effects, causing the users to re-edit. This not only lowers the creation efficiency, but also severely impacts the creative experience and flexibility of the users.

For this, the present disclosure provides a method for generating a video. First, beat point information of an audio for video editing is determined; a duration of at least one video clip among a plurality of video clips is adjusted based on the beat point information; and a video synced with music beat is finally generated according to the audio and the adjusted video clip. In this way, the video is automatically aligned with the beat point information, to effectively enhance the video generation efficiency. The adjustment is only made to the duration of the video clip, so as to generate an individualized video synced with music beat without compromising other editing functions.

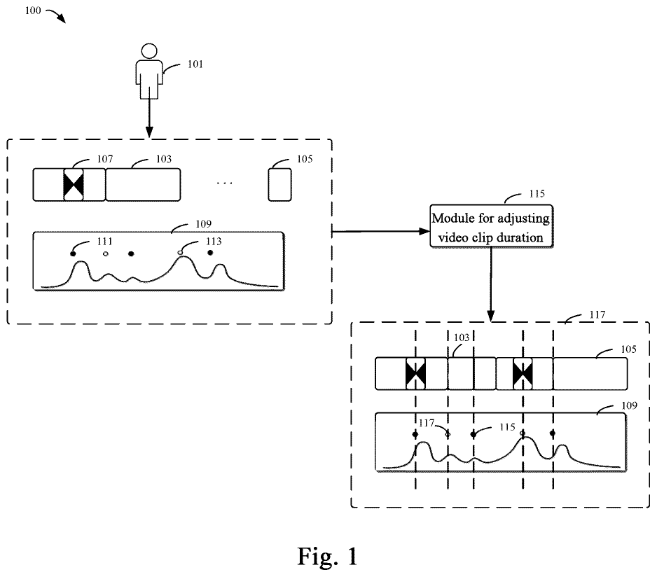

FIG. 1 illustrates a schematic diagram of an example environment 100 in which a plurality of embodiments of the present disclosure may be implemented. As shown in FIG. 1, the example environment 100 may include a plurality of video clips. The video clips may be a plurality of unedited source videos, and also may be a sequence of continuous images having specific starting point and end point extracted from a source video by the users 101. The users 101 may crop from the original video a desired video clip by setting the editing parameters, such as starting time and end time etc. The video clip may contain content from various sources, such as movies, TV programs, documentaries and short videos etc., and the content may be selected and combined according to the creative demands of the users 101. For example, in the example environment 100, the users 101 may edit a scene from a movie as a video clip 103 and edit another scene from a further documentary as a video clip 105. A plurality of video clips will be used for building a final video, to express specific stories or emotions through splicing, ranking and adding effects etc.

As shown in FIG. 1, a plurality of video clips may include a video clip 103 and a video clip 105. The users 101 may apply an overlapping transition 107 to two adjacent video clips. Overlapping transition 107 refers to an effect employed for switching between two adjacent video clips, such that a final part of the previous video clip and an opening part of the next video clip play in an overlapping mode for a period of time, thereby enabling a smooth transition. For example, at the first frame of the overlapping transition 107, the image of the previous video clip becomes transparent from being clear while the image of the current video clip becomes clear from being transparent. At the end frame of the overlapping transition 107, the image of the previous video clip may be completely transparent, i.e., no longer displayed; the image of the current video clip may be completely displayed to a clear state. Under the action of the overlapping transition 107, the previous video clip and the current video clip change simultaneously. The overlapping transition may last for a certain duration and may be adjusted according to preferences and creative demands of the users 101. The overlapping transition may create various unique visual effects, such as fade, dissolve, and slide etc., to enhance smoothness and view ability of the video.

According to FIG. 1, the example environment 100 also may include an audio 109, which may be an audio associated with the video clip as selected by the users 101. For example, the audio 109 may match the rhythm of the video clip, and the audio 109 and the video clip may be collectively used for building the final video synced with music beat. In some embodiments, the users may edit the video clip by applying speed change and transition based on the audio 109. The video is generated based on the edited video clip and audio 109. The audio 109 may be the entire source audio and also may be extracted from the source audio by the users 101. The audio 109 may include beat point information. In music beats, a beat point indicates a position where the first half beat meets the second half beat, to help determining the music rhythm. In some embodiments, the users 101 may download an audio template from the cloud. The template usually includes preset background music, sound effects and template beat point 111, i.e., specific rhythm point. In some embodiments, the users 101 also may record or import the entire source audio as demanded and edit the source audio. Meanwhile, the users also may set a customized beat point 113. In other words, markers are added to specific positions in the audio to guide switching or effect addition of the video clip, thereby achieving a more precise and coordinated audio-video synchronization.

In some embodiments, after a plurality of video clips and the beat point information of the audio 109 are determined, a module for adjusting video clip duration 115 adjusts durations of a plurality of video clips according to the beat point information, to generate a video 117. In the embodiments of the present disclosure, the module for adjusting video clip duration 115 is usually provided in a video processing system of a client and configured with a beat sync algorithm, to identify the beat point information in the audio and adjust the duration of the video clip according to the beat point information. In the process of generating the video 117, the beat points of the audio 109 would correspond to respective video editing points, the editing points including center position of the overlapping transition and the precise starting point or end point of the video clip. Accordingly, it is ensured that the audio rhythm is tightly bound to the visual elements of the video to present the desired beat point effects.

In some embodiments, the beat point information includes a starting time and an end time of each beat interval. A plurality of beat intervals of the audio 109 may be determined according to the beat point information. The beat interval may be a period of time between adjacent beat points. In some embodiments, the first frame and the end frame of the audio 109 also may be two beat points; a time period between the first frame and the first beat point of the audio 109 may be a first beat interval of the audio 109; and a time period between the last beat point and the end frame of the audio 109 may be the last beat interval of the audio 109. In the embodiments of the present disclosure, for each beat interval, the duration of one or more video clips corresponding to the beat interval may be adjusted, so as to align the video clip with the beat interval. For example, the duration of the video clip 103 is adjusted with respect to the beat interval between the beat point 117 and the beat point 115, such that the duration of the video clip 103 is consistent with the duration of the beat interval between the beat point 117 and the beat point 115.

Therefore, the video content can be automatically and accurately aligned with the beat point information in the audio, to massively simplify the complicated manual alignment in traditional video editing and further significantly improve the efficiency and quality of video generation. Moreover, such adjustment is made only on the duration of the video clip without affecting other editing functions of the video, such as transition effects, filter application and subtitle addition etc. This means that the users also can freely apply various editing techniques to enrich and perfect their video works while enjoying the convenience brought by the automatic beat sync.

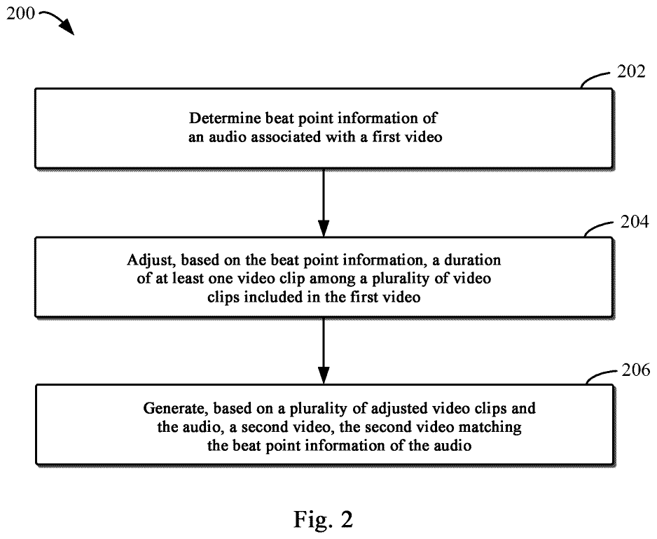

FIG. 2 illustrates a flowchart of a method 200 for generating a video in accordance with some embodiments of the present disclosure. The method 200 may be executed by a client, or a combination of client and server. The method 200 includes a block 202, a block 204 and a block 206.

As shown in FIG. 2, at block 202, beat point information of the audio associated with the first video is determined. Referring to FIG. 1, the first video may include a plurality of video clips related to the audio 109 and the audio 109, and a plurality of video clips are collectively used for building the final video synced with music beat. The beat point information of the audio 109 may be determined in various ways. On one hand, the client may automatically extract the beat point information from the audio downloaded from the cloud. Such audio file is usually processed and built-in with clear rhythm points or beat points. With a built-in algorithm or tool, the client can accurately identify and extract the beat points. On the other hand, the client also supports the users 101 to set the customized beat points 113 on their own. The user 101 may add the customized beat points 113 at any positions of the audio 109 according to their creative demands, characteristics of the content of the audio 109 or personal preferences. These customized beat points 113 may represent switching point of the video clip, triggering point of effects or other important audio-video synchronization points. By receiving and processing the customized beat points 113 set by the users, the client can further satisfy the individualized demands of the users in the video editing.

At block 204, the duration of at least one video clip in a plurality of video clips included among the first video is adjusted based on the beat point information. With reference to FIG. 1, after the plurality of video clips and the beat point information of the audio 109 are determined, the duration of a plurality of video clips may be adjusted by the module for adjusting video clip duration 115 according to the beat point information, to generate the video 117. In the embodiments of the present disclosure, the durations of one or more video clips corresponding to each beat interval may be adjusted, so as to align the video clip with the beat interval. For example, the duration of the video clip 103 is adjusted with respect to the beat interval between the beat point 117 and the beat point 115, such that the duration of the video clip 103 is consistent with the duration of the beat interval between the beat point 117 and the beat point 115. The starting point of the video clip 103 corresponds to the beat point 117 and the end point of the video clip 103 corresponds to the beat point 115.

At block 206, a second video is generated based on the plurality of adjusted video clips and the audio, the second video matching the beat point information of the audio. Referring to FIG. 1, the module for adjusting video clip duration 115 has adjusted the duration of the video clip corresponding to each beat interval, to ensure that the video clip is perfectly aligned with the beat interval. Afterwards, the client may synthesize a plurality of adjusted video clips and the audio 109 to generate a final video 117 (also known as second video). The video 117 not only contains video content and audio effects desired by the users, but also ensures the synchronization between the audio 109 and the video.

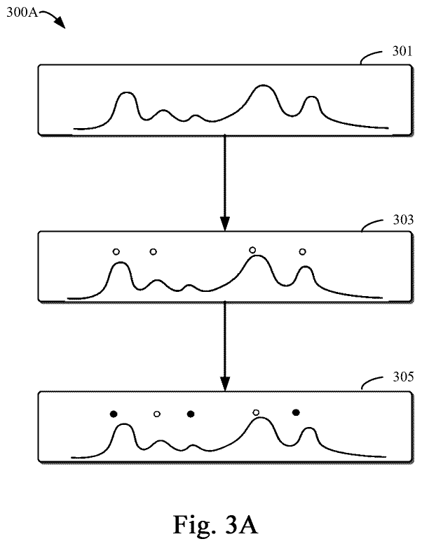

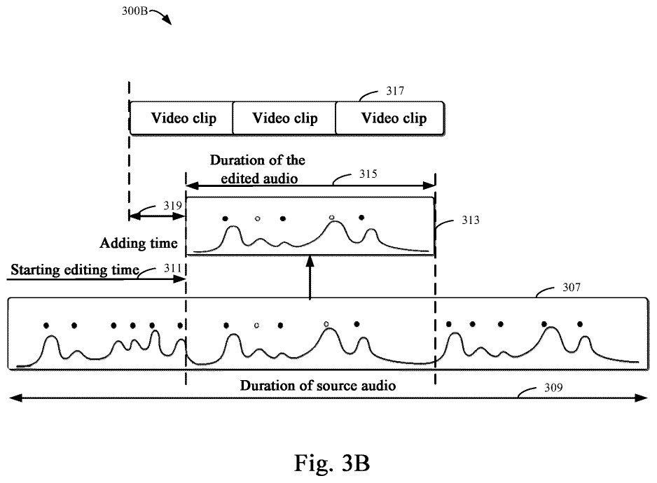

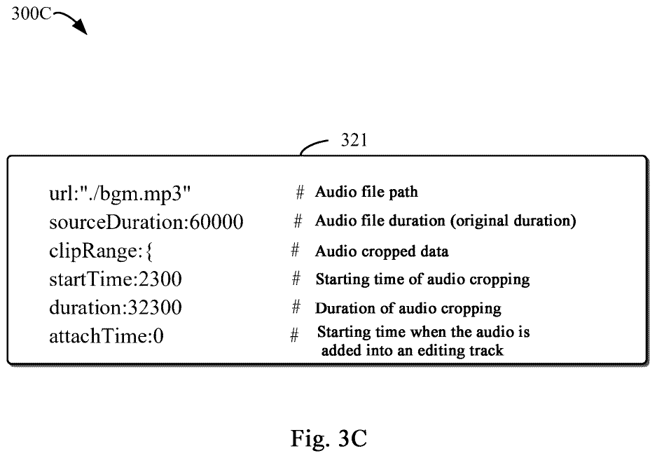

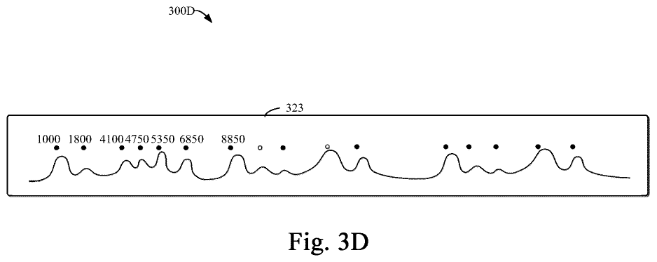

FIG. 3A illustrates a schematic diagram of the beat point information 300A of the audio in accordance with some embodiments of the present disclosure. As shown in FIG. 3A, audio 301, which may be obtained from editing audio materials input by the users or downloaded from the cloud, serves as the basis for subsequent editing and creation of the video synced with music beat. The audio 301 may originate from a clip edited from the source audio by the users and also may be obtained from a cloud audio library. On the basis of the audio 301, the client may execute an operation of identifying the beat point and may automatically identify a stressed part of the audio 301 using a stress analysis method. In addition, the client also may use a machine learning or deep learning model to further enhance the accuracy for identifying beat point.

In some embodiments, after the beat points in the audio 301 are identified, audio 303 including the beat point information is generated. In addition to the original content of the audio 301, the audio 303 also adds the beat point information, to provide more possibilities for users to edit and create. The users may further add customized beat points on the basis of the audio 303 to generate audio 305. The customized beat points may be added by the users manually or in other ways according to their needs. For example, the customized beat points are automatically generated by a tool or a third-party plug-in provided by the client. The audio 305 contains the audio content and the beat point information desired by the users. As such, the users may use the audio 305 to produce an individualized video synced with music beat.

FIG. 3B illustrates a schematic diagram of an editing audio 300B in accordance with some embodiments of the present disclosure. As shown in FIG. 3B, the source audio 307 may originate from the direct input of the users, e.g., sounds recorded by a device microphone, or audio materials downloaded from the cloud. Parameters of the source audio 307 may include a source audio duration 309 indicating a total play duration of the source audio 307, which is an indicator for measuring the volume of the audio content. Based on the source audio 307, the users may edit a particular clip, i.e., audio 313. Parameters of the audio 313 may include a starting editing time 311 and a duration of the edited audio 315. The starting editing time 311 refers to a position of a starting point of the audio 313 on a timeline of the source audio 307 and determines at which time the extraction of the audio 313 begins. The duration of the edited audio 315 indicates a total duration of the audio 313 from the starting point to the end point. When the audio 313 is combined with a plurality of video clips 317 to produce a video synced with music beat, an adding time 319 is generated accordingly. The adding time 319 represents a moment when the audio 313 is first introduced and presented synchronously with the video image during the playback of the video synced with music beat.

FIG. 3C illustrates a schematic diagram of generalized audio parameters 300C in accordance with some embodiments of the present disclosure. As shown in FIG. 3B, on the basis of the source audio 307, the users may edit a specific audio clip, i.e., audio 313. As the audio 313 is generated, its audio parameters 321 are also generated. According to FIG. 3C, audio parameters 321 may include an audio file path, an audio file duration, audio copping data, starting time of audio copping, duration of audio editing, and a starting time when the audio is added to an editing track. The audio file path is a file path of the source audio 307, indicating the storage position of the audio materials; the audio file duration refers to the duration of the source audio 309, reflecting the total play time of the source audio; the audio copping data include the specific content of the audio 313 extracted from the source audio, such as which part(s) of the audio are selected for subsequent editing and creation; the starting time of audio cropping is a starting editing time 311 for the audio 313, marking the position in the source audio 307 at which the extraction of the audio 313 begins; the duration of audio editing is the duration of the audio 315, indicating the lasting time of the audio 313; the starting time when the audio is added to an editing track is the adding time 319, which decides at which point of the finally generated video synced with music beat the audio 313 starts to play. The audio parameters 321 not only cover the basic information of the audio file, but also record the detailed data of the audio editing and the play time in the video, thereby serving as the basis for generating the video synced with music beat.

FIG. 3D illustrates a schematic diagram of the beat point data 300D in the audio in accordance with some embodiments of the present disclosure. As shown in FIG. 3D, the beat point data for audio 323 is typically represented in the form of a strictly monotonically increasing array. Each element indicates a time distance of a beat point with respect to the first frame of the original audio file, in unit of millisecond (ms). For example, the beat point data of the audio 323 may be represented as: [1000, 1800, 4100, 4750, 5350, 6850, 8850 . . . ]. In the embodiments of the present disclosure, for the sake of display effects of the video clip, during the generation of the beat data, the minimum duration between two beat points may be set to 100 ms, a duration from the first beat point to the first frame of the clip is at least 100 ms, and the duration from the last beat point to the end frame of the clip is at least 100 ms.

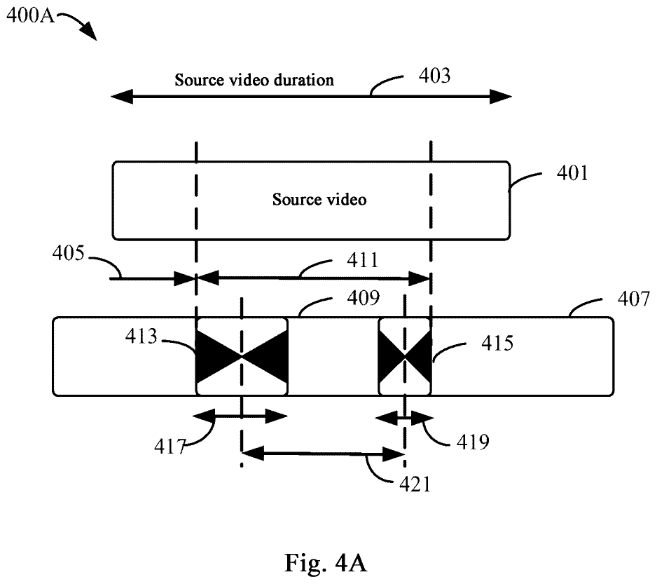

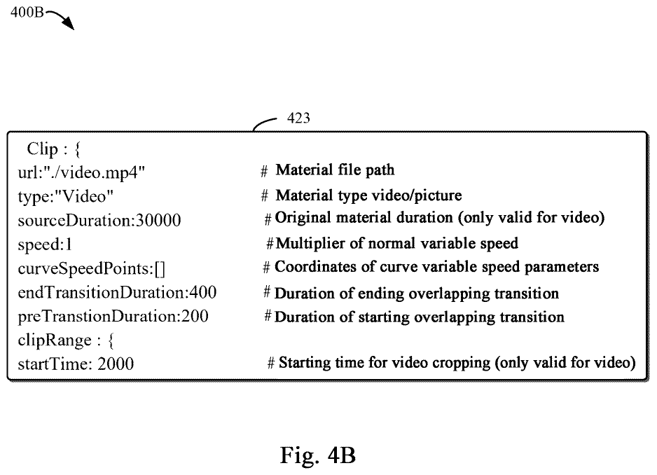

FIG. 4A illustrates a schematic diagram of generating a video clip 400A through video editing in accordance with some embodiments of the present disclosure. As shown in FIG. 4A, the source video 401 may come from the direct input of the users, and also may be video materials downloaded from the cloud. Parameters of the source video 401 include source video duration (clip.sourceDuration) 403 indicating the total playback duration of the source video 401. On the basis of the source video 401, the users may edit a particular video clip, i.e., video clip (clip) 409, the video clip 409 being a part of the video 407 including a plurality of video clips. Parameters of the video clip 409 may include a starting time for editing (clip.clipRange.startTime) 405, duration of video clip (clip.clipRange.duration) 411, duration of starting overlapping transition 413 (clip.preTransitionDuration) 417, duration of ending overlapping transition 415 (clip.endTransitionDuration) 419 and effective duration (EffectiveDuration) 421, the effective duration 421 also being known as second effective duration. The starting time for editing 405 refers to a position of the starting point of the video clip 409 on the timeline of the source video 401 and determines at which time the extraction of the video clip 409 begins. The duration of edited video clip 411 indicates a total duration of the video clip 409 from the starting point to the end point. The video clip 409 may include the starting overlapping transition 413 and/or the ending overlapping transition 415, and also may be free of overlapping transition. The number of overlapping transition (Transition_NUM) may be selected depending on the actual requirements.

In some embodiments, to ensure the display effects of the video clip 409, it is configured that the minimum duration (clipDuration_MIN) of each video clip 409 is 100 ms and the shortest duration of the overlapping transition (TransitionDuration_MIN) is also 100 ms. Of course, the durations of the video clip 409 and the overlapping transition may also be selected depending on the actual requirements, and the present disclosure is not limited in this regard. The cropping duration of the video clip 409 should be greater than or equal to sum of a half of the duration 417 of the starting overlapping transition 413 and a half of the duration 419 of the ending overlapping transition 415.

In some embodiments, the users may configure the video clip 409 with a normal speed change or a curve speed change. For the normal speed change, speed represents the multiplier of speed change; the video clip 409 having a duration of t, after being applied with the normal speed change, has a duration 411 of t/speed. As to the curve speed change, an average multiplier of speed change (averageSpeed) may be calculated by a speed change curve. As such, the video clip 409 in a duration of t, after being applied with the curve speed change, has a duration 411 of t/averageSpeed. When an actual duration of the clip after being applied with speed change is calculated, the minor differences between the curve speed change and the average speed change may be ignored to simplify the calculation. Instead, a multiplier of comprehensive speed (totalSpeed) is used for calculation. For the clips experiencing the normal speed change, the comprehensive speed change is equal to the multiplier of speed change. For the clips experiencing the curve speed change, their comprehensive speed change is equal to the average multiplier of speed change. As shown in FIG. 4, for the video clip 409 provided with speed change and overlapping transition, its effective duration 421 may be in a range indicated as follows:

$$[ clipDuration\_MIN , \begin{matrix}sourceDuration / totalSpeed - TransitionDuration\_MIN / 2 \times Transition\_NUM ] & ( 1 )\end{matrix}$$

FIG. 4B illustrates a schematic diagram of parameters 400B of the video clip in accordance with some embodiments of the present disclosure. As shown in FIG. 4A, the users may edit a specific video clip 409 from the source video 401. As the video clip 409 is generated, its video parameters 423 are also generated. According to FIG. 4B, the video parameters 423 may include material file path, material type, original material duration, multiplier of normal speed change, coordinates of curve speed change parameters, duration of ending overlapping transition, duration of starting overlapping transition and starting time for video editing. The material file path indicates a storage position of the source video 401 or a source picture. The material type shows that the material selected by the users is a video or a picture. When the material is a video, the effective duration 421 is shown in FIG. 4A; if the material is a picture, the effective duration may be set according to the actual needs. The original material duration represents the source video duration 403, reflecting the total play time of the source video 401. The starting time for video editing is starting editing time 405, marking the position in the source video 401 at which the extraction of the video clip 409 begins.

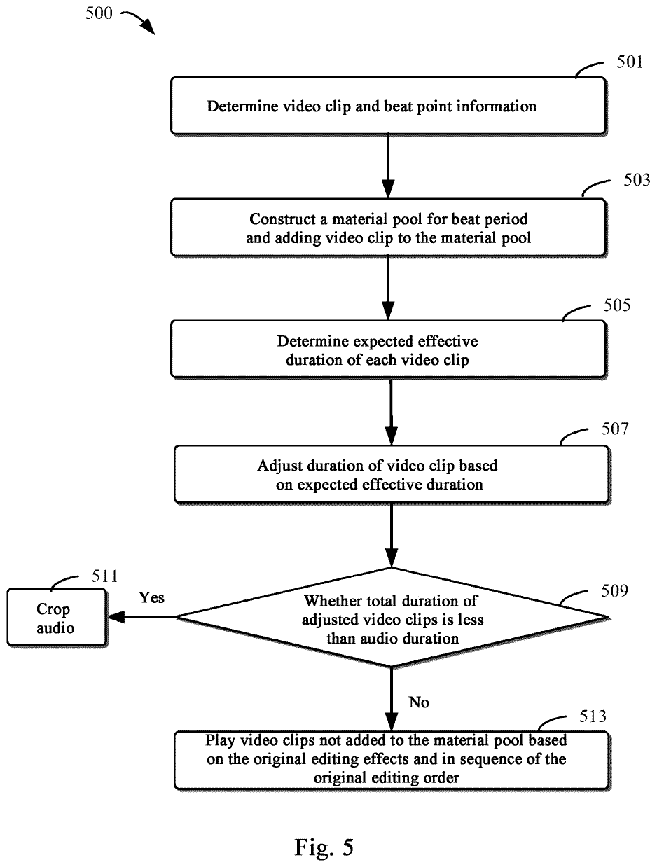

FIG. 5 illustrates a flowchart of a beat sync algorithm 500 in accordance with some embodiments of the present disclosure. At block 501, the video clip and the beat point information may be determined by the client. The video clip and the beat point information may be input by the users and may also be downloaded from the cloud. The video clip may be a clip extracted from a plurality of different source videos. The beat point information may include beat points automatically identified by the client, the beat points in the templates downloaded from the cloud and the user-customized beat points. After the beat information is determined, a plurality of beat intervals of the audio may be determined. For example, as shown in FIG. 3D, [0,1000] may be a first beat interval of the audio 323 and [1000,1800] may be a second beat interval of the audio 323. It is to be appreciated that the audio including n beat points has n+1 beat intervals.

At block 503, a material pool is constructed for the beat interval, and the video clip is added into the material pool. In the embodiments of the present disclosure, a material pool may be constructed for each beat interval. A list of material pools (List<MaterialPool>) may be obtained for a plurality of beat intervals. A list of material clips also may be constructed according to the video clip (List<Clip>). After the list of material pools and the list of material clips are obtained, they may be traversed successively from front to back by a double pointer. Video clips are taken out from the list of material clips in sequence and added to the material pool corresponding to each beat interval successively.

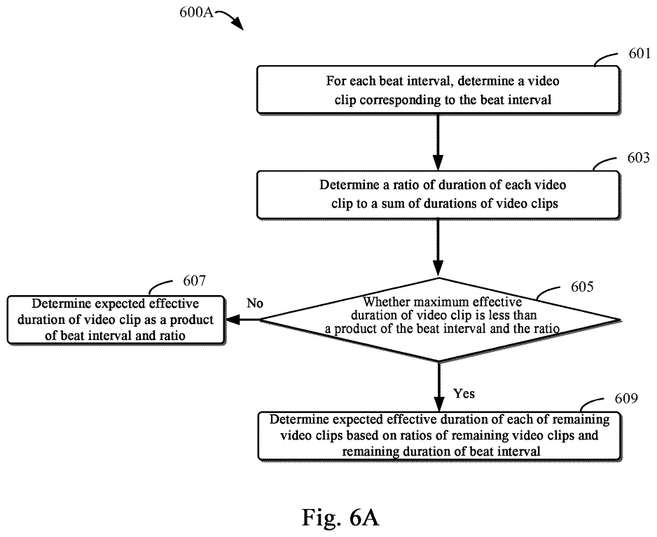

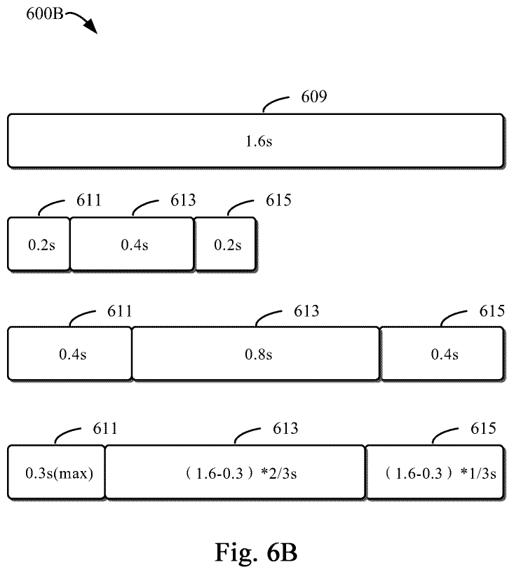

At block 505, an expected effective duration (also known as first effective duration) of each video clip is determined. In order to make the starting point of the video clip, the end point of the video clip or the center of the overlapping transition correspond to the starting beat point of the beat interval and the end beat point of the beat interval, it is required to ensure that a sum of maximum effective durations of all video clips in each material pool is greater than or equal to the duration of the beat interval. There is at most one material pool which depletes all video clips, but still fails to ensure that a sum of maximum effective durations of video clips is greater than or equal to the duration of the beat interval. Such material pool would skip the following steps and proceed step 513. In order to ensure that a sum of maximum effective durations of all video clips in each material pool is equal to the duration of the beat interval, it is required to adjust the duration of the video clip. In some embodiments, the expected effective duration (expectedEffectiveDuration) may be determined according to the ratio of the duration of each video clip. The detailed steps for determining the expected effective duration are introduced in FIG. 6A.

At block 507, the duration of the video clip is adjusted based on the expected effective duration. The method for adjusting the duration of the video clip may include cropping the video clip to make it shorter. Moreover, a new clip may be cropped from the source video corresponding to the video clip and added into the video clip, to extend the duration of the video clip. The duration of the overlapping transition of the video clip may also be adjusted. In some embodiments, during the adjustment of the video clip, the starting editing time for the video clip may be preferably kept unchanged, to protect continuity of the video story and the stability of the timeline. The part of the video clip, except for the overlapping transition, may be preferably adjusted to ensure the smoothness and the consistency of the transition effects and avoid damaging the natural transition due to the duration adjustment. A condition of keeping the comprehensive speed unchanged may also be configured, to guarantee the consistency in the rhythm and speed of the video.

At block 509, it is determined whether the total duration of the adjusted video clip is less than a duration of the audio. When the total duration of the adjusted video clip is less than the duration of the audio, perform block 511, cropping the audio. In case that the number of beat points is greater than the desired number of video clips, the redundant beat points are abandoned and the audio is reduced to the position where the last beat point for use is located, i.e., the end time of the audio track is adjusted to be the end time of the video. When the total duration of the adjusted video clip is greater than or equal to the duration of the audio, performing block 513, the video clips not added to the material pool may be played based on the original editing effects and in sequence of the original editing order. When the number of video clips is larger than the desired number of beat intervals or there is one material pool which depletes all video clips, but still fails to ensure that a sum of maximum effective durations of video clips is greater than or equal to the duration of the beat interval, the redundant video clips may be arranged in their original duration. Besides, the duration of the ending overlapping transition remains unchanged, the duration of the starting overlapping transition is aligned with the starting overlapping transition of the previous video clip, and the picture material may be arranged in 3 s by default.

FIG. 6A illustrates a flowchart of a method 600A for determining an expected effective duration of each video clip in accordance with some embodiments of the present disclosure. At block 601, a video clip corresponding to each beat interval is determined. As described above, after the list of material pools and the list of material clips are obtained, they may be traversed successively from front to back by a double pointer. Video clips are taken out from the list of material clips in sequence and added into each beat interval successively.

At block 603, a ratio (clip. ratio) of the duration of each video clips to a sum of durations of the video clips is determined. In the embodiments of the present disclosure, an index of the video clip in the material pool is represented by idx and the ratio is calculated starting from the video clip having idx of 0. The following steps are performed according to different ratios of each video clip. For example, the beat interval A corresponds to a video clip A having a duration of 0.3 s and a video clip B having a duration of 0.6 s. In such case, the ratio of the video clip A is 1/3 and the ratio of the video clip B is 2/3. At block 605, it is determined whether the maximum effective duration of the video clip is less than a product of the beat interval and the ratio. According to the above text, the maximum effective duration of the video clip is equal to entropy of the video duration and the comprehensive speed minus the shortest overlapping transition duration. In case that the maximum effective duration of the video clip is greater than or equal to a product of the duration of the beat interval and the ratio, it is indicated that the desired beat sync can be satisfied only by adjusting the duration of the video clip. It is determined by performing block 607 that the expected effective duration of the video clip is equal to a product of the duration of the beat interval and the ratio.

Continuing to refer to FIG. 6A, when the maximum effective duration of the video clip is less than a product of the beat interval and the ratio, it is indicated that the desired expected effective duration could not be satisfied even by extending the video clip to maximum. At block 609, the expected effective duration of each remaining video clip is determined based on the ratios of the remaining video clips and the remaining duration of the beat interval. In the embodiments of the present disclosure, the video clips which fail to satisfy the expected effective duration may be removed from the material pool first, and then the remaining duration is obtained by subtracting the maximum effective duration of the video clip from the duration of the beat interval. Next, a ratio of the duration of each remaining video clip to a sum of the durations of the remaining video clips is determined. In the end, the expected effective duration of each remaining video clip is determined according to a product of the ratio and the remaining duration.

FIG. 6B illustrates an effect picture of determining an expected effective duration 600B of each video clip in accordance with some embodiments of the present disclosure. As shown in FIG. 6B, the duration of the beat interval 609 is 1.6 s; the original duration of the video clip 611 is 0.2 s; the original duration of the video clip 613 is 0.4 s; and the original duration of the video clip 615 is 0.2 s. According to the method of FIG. 6A, the duration ratio of the video clip 611, the video clip 613 and the video clip 615 is 1:2:1. Then, the expected effective duration of each video clip is determined according to a product of each video clip and the beat interval 609. When the maximum effective duration of each video clip is greater than or equal to the expected effective duration, the expected effective durations of the video clip 611, the video clip 613 and the video clip 615 are 0.4 s, 0.8 s and 0.4 s respectively. When the maximum effective duration of the video clip 611 is 0.3 s, the maximum effective duration of the video clip 611 is subtracted from the duration of the beat interval 609 to obtain a remaining duration of 1.3 s. Then, the ratio of the duration of each remaining video clip to the sum of durations of the remaining video clips is determined. The duration ratio of the video clip 613 to the video clip 615 is 2:1. In the end, the expected effective duration of each remaining video clip is determined based on the product of the ratio and the remaining duration. The expected effective duration of the video clip 613 is equal to (1.6−0.3)*2/3 s and the expected effective duration of the video clip 615 is equal to (1.6−0.3)*1/3 s.

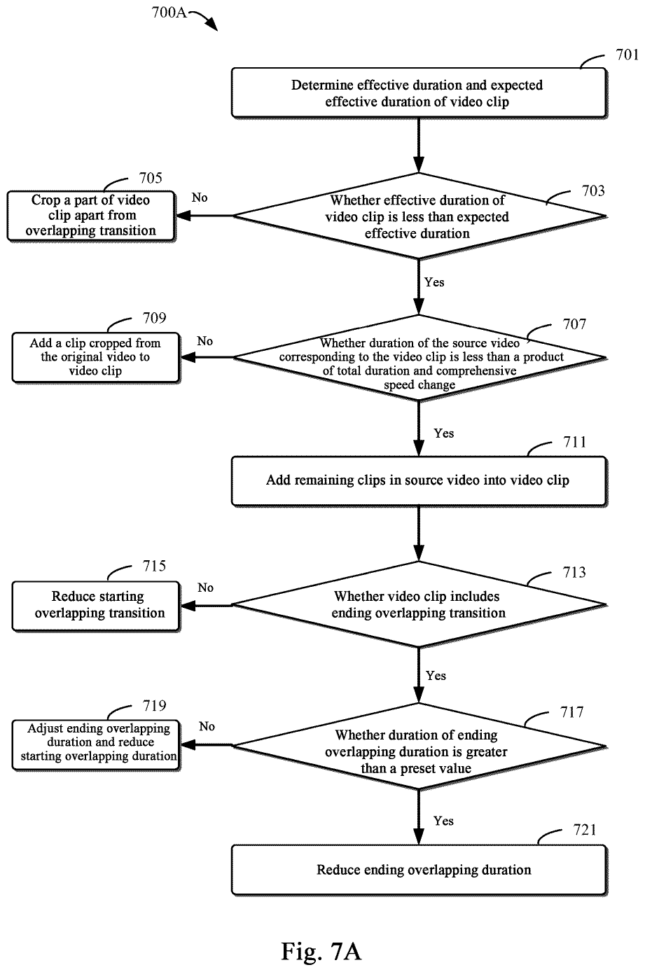

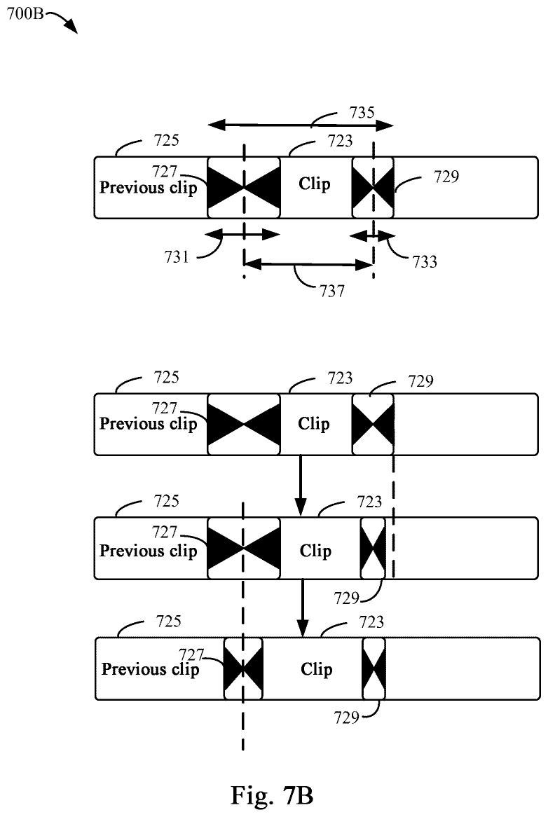

FIG. 7A illustrates a flowchart of a method 700A for adjusting the duration of the video clip in accordance with some embodiments of the present disclosure. At block 701, the effective duration and the expected effective duration of the video clip are determined. According to the steps in FIGS. 5 and 6A, after the effective duration and the expected effective duration of each video clip are determined, the following steps for duration adjustment may be performed on each video clip, such that the effective duration of each video clip is consistent with the expected effective duration. At block 703, it is determined whether the effective duration of the video clip is less than the expected effective duration. When the effective duration of the video clip is greater than the product, it is indicated that the current effective duration of the video clip is sufficient for satisfying the desired expected effective duration. At block 705, apart from the overlapping transition, the rest part of the video clip is cropped and the starting time for editing the video clip remains unchanged, such that the effective duration of the video clip is reduced to the expected effective duration. In some embodiments, on the condition that the formula (2) is satisfied, the duration of the video clip may be adjusted according to formula (3):

$$clip . clipRange . duration >= ( clip . preTransitionDuration / 2 + clip . expectedEffectiveDuration + clip . endTransitionDuration / 2 ) * totalSpeed \qquad ( 2 )$$

$$clip . clipRange . duration >= ( clip . preTransitionDuration / 2 + clip . expectedEffectiveDuration + clip . endTransitionDuration ) * totalSpeed \qquad ( 3 )$$

At block 707, it is determined whether the duration of the source video corresponding to the video clip is less than the product of the total duration and the comprehensive speed change. When the effective duration of the video clip is less than the expected effective duration, it is indicated that the current effective duration of the video clip is insufficient for satisfying the desired expected effective duration. It is required to edit a new clip from the source video and add it to the video clip, such that the effective duration of the video clip is extended to the expected effective duration. The total duration represents a sum of the expected effective duration, half of the duration of the starting overlapping transition of the video clip and half of the ending overlapping transition of the video clip. When the source video is greater than or equal to a product of the total duration and the comprehensive speed, performing block 709, a clip is cropped from the source video and added to the video clip to extend the effective duration of the video clip. In the embodiments of the present disclosure, the starting time for editing preferably remains unchanged. In some embodiments, on the condition that the formula (4) is satisfied, the duration of the video clip may be adjusted according to formula (5):

$$clip . sourceDuration >= ( clip . preTransitionDuration / 2 + clip . expectedEffectiveDuration + clip . endTransitionDuration / 2 ) * totalSpeed \qquad ( 4 )$$

$$clip . clipRange . duration = ( clip . preTransitionDuration / 2 + clip . expectedEffectiveDuration + clip . endTransitionDuration / 2 ) * totalSpeed , clip . clipRange . startTime = clip . sourceDuration - clip . clipRange . duration \qquad ( 5 )$$

At block 711, the remaining clip in the source video is added to the video clip. When the source video is less than the product of the total duration and the comprehensive speed, it is indicated that even if the video clip is extended by depleting the new clips edited from the source video, the desired expected effective duration still could not be satisfied. The remaining clips in the source video are added to the video clip. In some embodiments, on the condition that the formula (6) is satisfied, the duration of the video clip may be adjusted according to formula (7):

$$clip . sourceDuration < ( clip . preTransitionDuration / 2 + clip . expectedEffectiveDuration + clip . endTransitionDuration / 2 ) * totalSpeed \qquad ( 6 )$$

$$clip . clipRange . startTime = 0 , clip . clipRange . duration = clip . sourceDuration \qquad ( 7 )$$

At block 713, it is determined whether the video clip contains an ending overlapping transition. In case that the desired expected effective duration still could not be satisfied when the video clip is extended by depleting the new clips edited from the source video, it is required to adjust the duration of the overlapping transition, such that the effective duration of the video clip is consistent with the expected effective duration. In the embodiments of the present disclosure, a policy is adopted to adjust the ending overlapping transition first and then the starting overlapping transition. At the absence of the ending overlapping transition, performing 715, the duration of the starting overlapping transition is reduced, such that the effective duration of the video clip is consistent with the expected effective duration. In some embodiments, on the condition that the formula (8) is satisfied, the duration of the starting overlapping transition may be adjusted according to formula (9):

$$clip . endTransitionDuration = 0 , clip . sourceDuration / totalSpeed - clip . preTransitionDuration / 2 - clip . expectedEffectiveDuration < 0 \qquad ( 8 )$$

$$clip . preTransitionDuration = ( clip . sourceDuration / totalSpeed - clip . expectedEffectiveDuration ) * 2 \qquad ( 9 )$$

At the presence of the ending overlapping transition, performing block 717, it is determined whether the duration of the ending overlapping transition is greater than a preset value. When the duration of the ending overlapping transition is less than the preset value, performing block 719, the duration of the ending overlapping transition is extended until reaching the preset value and the duration of the starting overlapping transition is reduced, such that the effective duration of the video clip is consistent with the expected effective duration. In some embodiments, on the condition that the formula (10) is satisfied, the duration of the overlapping transition may be adjusted according to formula (11):

$$clip . sourceDuration / totalSpeed - clip . preTransitionDuration \text{} / 2 - clip . expectedEffectiveDuration < 50 ms \qquad ( 10 )$$

$$clip . endTransitionDuration = 100 ms , clip . preTransitionDuration = ( clip . sourceDuration / totalSpeed - clip . endTransitionDuration / 2 - clip . expectedEffectiveDuration ) * 2 \qquad ( 11 )$$

When the duration of the ending overlapping transition is greater than the preset value, performing block 721, the duration of the ending overlapping transition is reduced, such that the effective duration of the video clip is consistent with the expected effective duration. In some embodiments, on the condition that the formula (12) is satisfied, the duration of the overlapping transition may be adjusted according to formula (13):

$$clip . endTransitionDuration > 0 , clip . sourceDuration / totalSpeed - clip . preTransitionDuration \text{} / 2 - clip . expectedEffectiveDuration >= 50 ms \qquad ( 12 )$$

$$clip . endTransitionDuration = ( clip . sourceDuration / totalSpeed - clip . preTransitionDuration \text{} / 2 - clip . expectedEffectiveDuration ) * 2 \qquad ( 13 )$$

FIG. 7B illustrates a schematic diagram of adjusting the ending overlapping transition and/or the starting overlapping transition 700B in accordance with some embodiments of the present disclosure. As shown in FIG. 7B, when the effective duration 737 of the video clip 723 is less than the expected effective duration and the duration 735 of the video clip 723 is equal to the duration of the source video, it is required to adjust the duration of the overlapping transition, such that the effective duration 737 of the video clip 723 is consistent with the expected effective duration. It is to be appreciated that when the duration 735 of the video clip 723 has reached the maximum value, i.e., the duration of the source video, the effective duration 737 may be extended by reducing the duration 733 and/or the duration 731 while the duration 735 remains unchanged because the duration 735 is a sum of a product of the effective duration 737 and the comprehensive speed change, the duration 733 of the ending overlapping transition 729 and the duration 727 of the starting overlapping transition 731. In the embodiments of the present disclosure, when the duration 733 of the ending overlapping transition 729 is greater than the preset value, the duration 733 is reduced first. The starting overlapping transition 727 is adjusted when no adjustments could be made to the ending overlapping transition 729, while the center time point of the starting overlapping transition 727 remains unchanged. In this way, the integrity of the video clip is guaranteed and the demands of the users for video rhythm and effects are also satisfied.

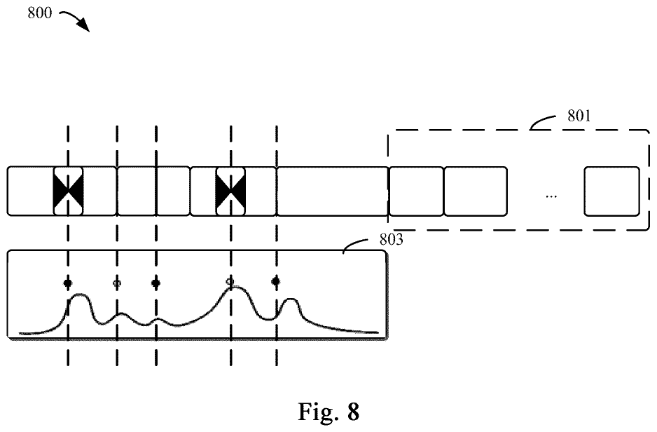

FIG. 8 illustrates an effect graph of generating a video 800 in accordance with some embodiments of the present disclosure. As shown in FIG. 8, when the number of video clips is greater than the desired number of beat intervals, firstly, the video clips with completed beat sync are arranged in sequence according to the requirements of the beat interval, to align and integrate with the audio 803. After the arrangement of the video clips with completed beat sync is completed, if there is an additional video clip 801, it would be arranged after the video clips with completed beat sync. To maintain the overall smoothness and continuity, the video clips 801 may be arranged in their original duration. The starting overlapping transition of one video clip should be aligned with the ending overlapping transition of a previous video clip, to ensure a smoother transition between the video clips without causing abrupt jumps or breaks.

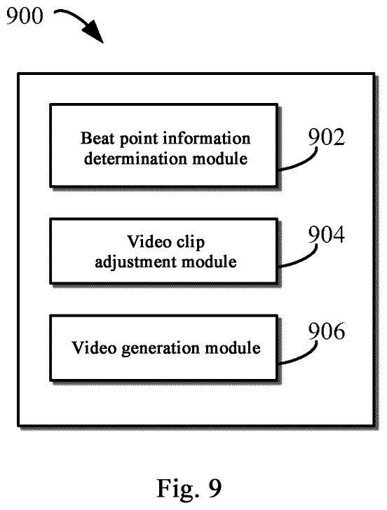

FIG. 9 illustrates a block diagram of an apparatus 900 for generating a video in accordance with some embodiments of the present disclosure. As shown in FIG. 9, the apparatus 900 comprises a beat point information determination module 902 configured to determine beat point information of an audio associated with a first video. The apparatus 900 also comprises a video clip adjustment module 904 configured to adjust, based on the beat point information, a duration of at least one video clip among a plurality of video clips included in the first video. The apparatus 900 further comprises a video generation module 906 configured to generate, based on a plurality of adjusted video clips and the audio, a second video, the second video matching beat point information of the audio.

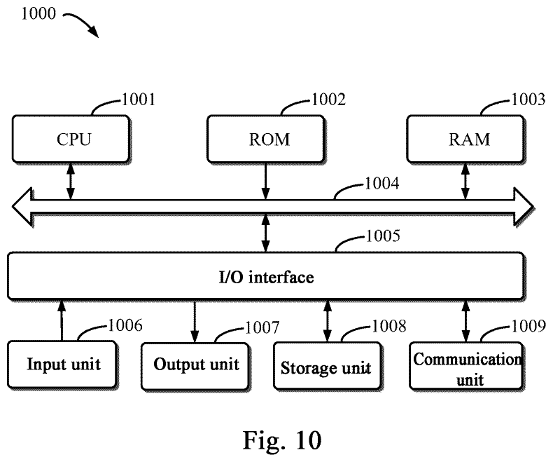

FIG. 10 illustrates a block diagram of a device 1000 capable of implementing a plurality of embodiments of the present disclosure. As shown in FIG. 10, the device 1000 comprises a central process unit (CPU) and/or graphic processing unit (GPU) 1001, which can execute various suitable actions and processing based on the computer program instructions stored in the read-only memory (ROM) 1002 or computer program instructions loaded in the random-access memory (RAM) 1003 from the storage unit 1008. The RAM 1003 can also store all kinds of programs and data required by the operation of the device 1000. CPU/GPU 1001, ROM 1002 and RAM 1003 are connected to each other via a bus 1004. The input/output (I/O) interface 1005 is also connected to the bus 1004. Although not illustrated in FIG. 10, the device 1000 also may include a coprocessor.

A plurality of components in the device 1000 is connected to the I/O interface 1005, including: an input unit 1006, such as keyboard, mouse and the like; an output unit 1007, e.g., various kinds of display and loudspeakers etc.; a storage unit 1008, such as disk and optical disk etc.; and a communication unit 1009, such as network card, modem, wireless transceiver and the like. The communication unit 1009 allows the device 1000 to exchange information/data with other devices via the computer network, such as Internet, and/or various telecommunication networks.

The above described respective methods can be executed by the GPU/CPU 1001. For example, in some embodiments, the method can be implemented as a computer software program tangibly included in the machine-readable medium, e.g., storage unit 1008. In some embodiments, the computer program can be partially or fully loaded and/or mounted to the apparatus 1000 via ROM 1002 and/or communication unit 1009. When the computer program is loaded to RAM 1003 and executed by the CPU/GPU 1001, one or more steps or actions of the above described method or procedure may be executed.

In some embodiments, the above described method and procedure may be implemented as a computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages and traditional procedural programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by device, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection for terms in the text aims to best explain principles and actual applications of each embodiment and technical improvements made in the market by each embodiment, or enable those ordinary skilled in the art to understand embodiments of the present disclosure.

Some example implementations are listed below.

Example 1. A method for generating a video, comprising:
determining beat point information of an audio associated with a first video;
adjusting, based on the beat point information, a duration of at least one video clip among a plurality of video clips comprised in the first video; and
generating, based on a plurality of adjusted video clips and the audio, a second video, the second video matching the beat point information of the audio.

Example 2. The method of Example 1, wherein adjusting the duration of the at least one video clip among the plurality of video clips comprised in the first video comprises:
determining, based on the beat point information, a plurality of beat intervals between adjacent beat points;
determining, based on the plurality of beat intervals, a first effective duration of each video clip; and
adjusting, based on the first effective duration, the duration of the at least one video clip among the plurality of video clips.

Example 3. The method of any of Examples 1-2, wherein determining the first effective duration of each video clip comprises:
for each beat interval among the plurality of beat intervals, determining a video clip corresponding to the beat interval;
determining a ratio of a duration of each video clip among the plurality of video clips to a sum of durations of the video clips; and
determining the first effective duration of each video clip among the plurality of video clips based on the ratio of each video clip among the plurality of video clips and a duration of the beat interval.

Example 4. The method of any of Examples 1-3, wherein the video clips comprise a first video clip and remaining video clips, a ratio of a duration of the first video clip to the sum of the durations of the video clips is a first ratio, a maximum effective duration of the first video clip is equal to entropy of a duration of a first source video and comprehensive speed change minus a duration of a shortest overlapping transition, and wherein determining the first effective duration of each video clip further comprises:
determining whether the maximum effective duration of the first video clip is less than a product of the first ratio and the duration of the beat interval;
in response to the maximum effective duration of the first video clip being less than the product of the first ratio and the duration of the beat interval, determining a first effective duration of the first video clip as the maximum effective duration;
generating a remaining duration by subtracting the maximum effective duration from the duration of the beat interval; and
determining a first effective duration of each of the remaining video clips based on a ratio of a duration of each of the remaining video clips to a sum of durations of the remaining video clips, and the remaining duration.

Example 5. The method of any of Examples 1-4, wherein an effective time period of the video clip is a time period from a starting point of the video clip or a midpoint of a starting overlapping transition to an endpoint or a midpoint of an ending overlapping transition, the plurality of video clips comprise a second video clip, and wherein adjusting the duration of the at least one video clip among the plurality of video clips comprises:
determining whether a second effective duration of the second video clip corresponding to the effective time period is less than a first effective duration of the second video clip;
in response to the second effective duration of the second video clip being greater than the first effective duration of the second video clip, cropping a part of the second video clip apart from an overlapping transition and keeping an edit starting time of the second video clip unchanged; and
in response to a second effective duration of the second video clip being equal to the first effective duration of the second video clip, keeping the second effective duration of the second video clip unchanged.

Example 6. The method of any of Examples 1-5, wherein a sum of the first effective duration, a half of a duration of a starting overlapping transition of the second video clip and a half of a duration of an ending overlapping transition duration of the second video clip is a total duration, and wherein the method further comprising:
in response to the second effective duration of the second video clip being less than the first effective duration of the second video clip, determining whether entropy of a duration of a second source video corresponding to the second video clip and comprehensive speed change is less than the total duration;
in response to the entropy of the duration of the second source video and the comprehensive speed change being greater than or equal to the total duration, cropping a clip from the second source video; and
adding the cropped clip to the second video clip.

Example 7. The method of any of Examples 1-6, wherein the second video clip comprises a start editing time and an end editing time, and wherein cropping the clip from the second source video comprises:
cropping, from the second source video, a clip subsequent to the end editing time to keep the start editing time unchanged.

Example 8. The method of any of Examples 1-7, further comprising:
in response to the entropy of the duration of the second source video and the comprehensive speed change being less than the total duration, adding remaining clips in the second source video, except for the second video clip, to the second video clip;
determining whether the second video clip has an ending overlapping transition;
in response to presence of the ending overlapping transition in the second video clip, determining whether the duration of the ending overlapping transition of the second video clip is greater than a preset value; and
in response to the duration of the ending overlapping transition of the second video clip being greater than the preset value, reducing the duration of the ending overlapping transition.

Example 9. The method of any of Examples 1-8, further comprising:
in response to the duration of the ending overlapping transition of the second video clip being less than the preset value, adjusting the duration of the ending overlapping transition to the preset value; and
reducing the duration of the starting overlapping transition of the second video clip.

Example 10. further comprising:
in response to absence of the ending overlapping transition in the second video clip, reducing the duration of the starting overlapping transition of the second video clip.

Example 11. The method of any of Examples 1-10, wherein generating the second video comprises:
in response to a sum of durations of the plurality of adjusted video clips being greater than a duration of the audio, playing a part of the video clips subsequent to an end of the audio, based on original editing effects and in a sequence of original editing order.

Example 12. The method of any of Examples 1-11, wherein generating the second video further comprises:
in response to the duration of the audio being greater than the sum of the durations of the plurality of adjusted video clips, cropping the audio, such that the duration of the audio is consistent with the sum of the durations of the plurality of adjusted video clips.

Example 13. An apparatus for generating a video, comprising:
a beat point information determining module configured to determine beat point information of an audio associated with a first video;
a video clip adjusting module configured to adjust, based on the beat point information, a duration of at least one video clip among a plurality of video clips comprised in the first video; and
a video generating module configured to generate, based on a plurality of adjusted video clips and the audio, a second video, the second video matching the beat point information of the audio.

Example 14. The apparatus of Example 13, wherein the video clip adjusting module comprises:
a beat interval duration determining module configured to determine, based on the beat point information, a plurality of beat intervals between adjacent beat points;
a first effective duration determining module configured to determine, based on the plurality of beat intervals, a first effective duration of each video clip; and
a duration adjusting module configured to adjust, based on the first effective duration, the duration of the at least one video clip among the plurality of video clips.

Example 15. The apparatus of any of Examples 13-14, wherein the first effective duration determining module comprises:
a video clip determining module configured to, determine a video clip corresponding to the beat interval, for each beat interval among the plurality of beat intervals;
a ratio determining module configured to determine a ratio of a duration of each video clip among the plurality of video clips to a sum of durations of the video clips; and
a first first effective duration determining module configured to determine the first effective duration of each video clip among the plurality of video clips based on the ratio of each video clip among the plurality of video clips and a duration of the beat interval

Example 16. The apparatus of any of Examples 13-15, wherein the video clips comprise a first video clip and remaining video clips, a ratio of a duration of the first video clip to the sum of the durations of the video clips is a first ratio, a maximum effective duration of the first video clip is equal to entropy of a duration of a first source video and comprehensive speed change minus a duration of a shortest overlapping transition, and wherein the first effective module further comprises:
a first computing module configured to determine whether the maximum effective duration of the first video clip is less than a product of the first ratio and the duration of the beat interval;
a first duration determining module configured to, in response to the maximum effective duration of the first video clip being less than the product of the first ratio and the duration of the beat interval, determine a first effective duration of the first video clip as the maximum effective duration;
a remaining duration generating module configured to generate a remaining duration by subtracting the maximum effective duration from the duration of the beat interval; and
a second first effective duration determining module configured to determine a first effective duration of each of the remaining video clips based on a ratio of a duration of each of the remaining video clips to a sum of durations of the remaining video clips, and the remaining duration.

Example 17. The apparatus of any of Examples 13-16, wherein an effective time period of the video clip is a time period from a starting point of the video clip or a midpoint of a starting overlapping transition to an endpoint or a midpoint of an ending overlapping transition, the plurality of video clips comprise a second video clip, and wherein duration adjusting module comprises:
a second computing module configured to determine whether a second effective duration of the second video clip corresponding to the effective time period is less than a first effective duration of the second video clip;
a first duration adjusting module configured to, in response to the second effective duration of the second video clip being greater than the first effective duration of the second video clip, crop a part of the second video clip apart from an overlapping transition and keep an edit starting time of the second video clip unchanged; and
a second duration adjusting module configured to, in response to a second effective duration of the second video clip being equal to the first effective duration of the second video clip, keep the second effective duration of the second video clip unchanged.

Example 18. The apparatus of any of Examples 13-17, wherein a sum of the first effective duration, a half of a duration of a starting overlapping transition of the second video clip and a half of a duration of an ending overlapping transition duration of the second video clip is a total duration, and wherein the method further comprising:
a third computing module configured to, in response to the second effective duration of the second video clip being less than the first effective duration of the second video clip, determine whether entropy of a duration of a second source video corresponding to the second video clip and comprehensive speed change is less than the total duration;
a first clip cropping module configured to, in response to the entropy of the duration of the second source video and the comprehensive speed change being greater than or equal to the total duration, crop a clip from the second source video; and
a first clip adding module configured to add the cropped clip to the second video clip.

Example 19. The apparatus of any of Examples 13-18, wherein the second video clip comprises a start editing time and an end editing time, and wherein the first clip cropping module comprises:
a starting time maintaining module configured to crop from the second source video, a clip subsequent to the end editing time to keep the start editing time unchanged.

Example 20. The apparatus of any of Examples 13-19, further comprising:
a second clip adding module configured to, in response to the entropy of the duration of the second source video and the comprehensive speed change being less than the total duration, add remaining clips in the second source video, except for the second video clip, to the second video clip;
an ending overlapping transition determining module configured to determine whether the second video clip has an ending overlapping transition;
a fourth calculating module configured to, in response to presence of the ending overlapping transition in the second video clip, determining whether the duration of the ending overlapping transition of the second video clip is greater than a preset value; and
a first ending overlapping transition adjusting module configured to, in response to the duration of the ending overlapping transition of the second video clip being greater than the preset value, reduce the duration of the ending overlapping transition.

Example 21. The apparatus of any of Examples 13-20, further comprising:
a second module for adjusting ending overlapping transition configured to, in response to the duration of the ending overlapping transition of the second video clip being less than the preset value, adjust the duration of the ending overlapping transition to the preset value; and
a first starting overlapping transition adjusting module configured to the duration of the starting overlapping transition of the second video clip.

Example 22. The apparatus of any of Examples 13-21, further comprising:
a second ending overlapping transition adjusting module configured to, in response to absence of the ending overlapping transition in the second video clip, reducing the duration of the starting overlapping transition of the second video clip.

Example 23. The apparatus of any of Examples 13-22, wherein the video generating module comprises:
a video arrangement module configured to, in response to a sum of durations of the plurality of adjusted video clips being greater than a duration of the audio, play a part of the video clips subsequent to an end of the audio, based on original editing effects and in a sequence of original editing order.

Example 24. The apparatus of any of Examples 13-23, wherein the video generating module comprises:
an audio cropping module configured to, in response to the duration of the audio being greater than the sum of the durations of the plurality of adjusted video clips, crop the audio, such that the duration of the audio is consistent with the sum of the durations of the plurality of adjusted video clips.

Example 25. An electronic device, comprising:
a processor; and
a memory coupled to the processor and having instructions stored therein, wherein the instructions, when executed by a processor, cause the electronic device to execute acts comprising:
determining beat point information of an audio associated with a first video;
adjusting, based on the beat point information, a duration of at least one video clip among a plurality of video clips comprised in the first video; and
generating, based on a plurality of adjusted video clips and the audio, a second video, the second video matching the beat point information of the audio.

Example 26. The electronic device of Example 25, wherein adjusting the duration of the at least one video clip among the plurality of video clips comprised in the first video comprises:
determining, based on the beat point information, a plurality of beat intervals between adjacent beat points;
determining, based on the plurality of beat intervals, a first effective duration of each video clip; and
adjusting, based on the first effective duration, the duration of the at least one video clip among the plurality of video clips.

Example 27. The electronic device of any of Examples 25-26, wherein determining the first effective duration of each video clip comprises:
for each beat interval among the plurality of beat intervals, determining a video clip corresponding to the beat interval;
determining a ratio of a duration of each video clip among the plurality of video clips to a sum of durations of the video clips; and
determining the first effective duration of each video clip among the plurality of video clips based on the ratio of each video clip among the plurality of video clips and a duration of the beat interval.

Example 28. The electronic device of any of Examples 25-27, wherein the video clips comprise a first video clip and remaining video clips, a ratio of a duration of the first video clip to the sum of the durations of the video clips is a first ratio, a maximum effective duration of the first video clip is equal to entropy of a duration of a first source video and comprehensive speed change minus a duration of a shortest overlapping transition, and wherein determining the first effective duration of each video clip further comprises:
determining whether the maximum effective duration of the first video clip is less than a product of the first ratio and the duration of the beat interval;
in response to the maximum effective duration of the first video clip being less than the product of the first ratio and the duration of the beat interval, determining a first effective duration of the first video clip as the maximum effective duration;
generating a remaining duration by subtracting the maximum effective duration from the duration of the beat interval; and
determining a first effective duration of each of the remaining video clips based on a ratio of a duration of each of the remaining video clips to a sum of durations of the remaining video clips, and the remaining duration.

Example 29. The electronic device of any of Examples 25-28, wherein an effective time period of the video clip is a time period from a starting point of the video clip or a midpoint of a starting overlapping transition to an endpoint or a midpoint of an ending overlapping transition, the plurality of video clips comprise a second video clip, and wherein adjusting the duration of the at least one video clip among the plurality of video clips comprises:
determining whether a second effective duration of the second video clip corresponding to the effective time period is less than a first effective duration of the second video clip;
in response to the second effective duration of the second video clip being greater than the first effective duration of the second video clip, cropping a part of the second video clip apart from an overlapping transition and keeping an edit starting time of the second video clip unchanged; and
in response to a second effective duration of the second video clip being equal to the first effective duration of the second video clip, keeping the second effective duration of the second video clip unchanged.

Example 30. The electronic device of any of Examples 25-29, wherein a sum of the first effective duration, a half of a duration of a starting overlapping transition of the second video clip and a half of a duration of an ending overlapping transition duration of the second video clip is a total duration, and wherein the method further comprising:
in response to the second effective duration of the second video clip being less than the first effective duration of the second video clip, determining whether entropy of a duration of a second source video corresponding to the second video clip and comprehensive speed change is less than the total duration;
in response to the entropy of the duration of the second source video and the comprehensive speed change being greater than or equal to the total duration, cropping a clip from the second source video; and
adding the cropped clip to the second video clip.

Example 31. The electronic device of any of Examples 25-30, wherein the second video clip comprises a start editing time and an end editing time, and wherein cropping the clip from the second source video comprises:
cropping, from the second source video, a clip subsequent to the end editing time to keep the start editing time unchanged.

Example 32. The electronic device of any of Examples 25-31, further comprising:
in response to the entropy of the duration of the second source video and the comprehensive speed change being less than the total duration, adding remaining clips in the second source video, except for the second video clip, to the second video clip;
determining whether the second video clip has an ending overlapping transition;
in response to presence of the ending overlapping transition in the second video clip, determining whether the duration of the ending overlapping transition of the second video clip is greater than a preset value; and
in response to the duration of the ending overlapping transition of the second video clip being greater than the preset value, reducing the duration of the ending overlapping transition.

Example 33. The electronic device of any of Examples 25-32, further comprising:
in response to the duration of the ending overlapping transition of the second video clip being less than the preset value, adjusting the duration of the ending overlapping transition to the preset value; and
reducing the duration of the starting overlapping transition of the second video clip.

Example 34. The electronic device of any of Examples 25-33, further comprising:
in response to absence of the ending overlapping transition in the second video clip, reducing the duration of the starting overlapping transition of the second video clip.

Example 35. The electronic device of any of Examples 25-34, wherein generating the second video comprises:
in response to a sum of durations of the plurality of adjusted video clips being greater than a duration of the audio, playing a part of the video clips subsequent to an end of the audio, based on original editing effects and in a sequence of original editing order.

Example 36. The electronic device of any of Examples 25-35, wherein generating the second video further comprises:
in response to the duration of the audio being greater than the sum of the durations of the plurality of adjusted video clips, cropping the audio, such that the duration of the audio is consistent with the sum of the durations of the plurality of adjusted video clips.

Example 37. A computer-readable storage medium with computer-executable instructions stored thereon, wherein the computer-executable instructions, when executed by a processor, implement the method according to any of Examples 1-12.

Example 38. A computer program product tangibly stored on a computer-readable medium and including computer-executable instructions, wherein the computer-executable instructions, when executed by a device, cause the device to implement the method according to any of Examples 1-12.

Although the present disclosure has been described in a language specific to structural features and/or logical actions of the methods, it should be understood that the subject matter defined in the appended claims is not necessarily limited to the specific features or actions described above. On the contrary, the specific features and actions described above are only exemplary forms for implementing the claims.

I/We claim:

1. A method for generating a video, comprising:
determining beat point information of an audio associated with a first video;
adjusting, based on the beat point information, a duration of at least one video clip among a plurality of video clips included in the first video; and
generating, based on a plurality of adjusted video clips and the audio, a second video, the second video matching the beat point information of the audio.

2. The method of claim 1, wherein adjusting the duration of the at least one video clip among the plurality of video clips included in the first video comprises:
determining, based on the beat point information, a plurality of beat intervals between adjacent beat points;
determining, based on the plurality of beat intervals, a first effective duration of each video clip; and
adjusting, based on the first effective duration, the duration of the at least one video clip among the plurality of video clips.

3. The method of claim 2, wherein determining the first effective duration of each video clip comprises:
for each beat interval among the plurality of beat intervals, determining a video clip corresponding to the beat interval;
determining a ratio of a duration of each video clip among the plurality of video clips to a sum of durations of the video clips; and
determining the first effective duration of each video clip among the plurality of video clips based on the ratio of each video clip among the plurality of video clips and a duration of the beat interval.

4. The method of claim 3, wherein the video clips include a first video clip and remaining video clips, a ratio of a duration of the first video clip to the sum of the durations of the video clips is a first ratio, a maximum effective duration of the first video clip is equal to entropy of a duration of a first source video and comprehensive speed change minus a duration of a shortest overlapping transition, and wherein determining the first effective duration of each video clip further comprises:
determining whether the maximum effective duration of the first video clip is less than a product of the first ratio and the duration of the beat interval;
in response to the maximum effective duration of the first video clip being less than the product of the first ratio and the duration of the beat interval, determining a first effective duration of the first video clip as the maximum effective duration;
generating a remaining duration by subtracting the maximum effective duration from the duration of the beat interval; and
determining a first effective duration of each of the remaining video clips based on a ratio of a duration of each of the remaining video clips to a sum of durations of the remaining video clips, and the remaining duration.

5. The method of claim 2, wherein an effective time period of the video clip is a time period from a starting point of the video clip or a midpoint of a starting overlapping transition to an endpoint or a midpoint of an ending overlapping transition, the plurality of video clips include a second video clip, and wherein adjusting the duration of the at least one video clip among the plurality of video clips comprises:
determining whether a second effective duration of the second video clip corresponding to the effective time period is less than a first effective duration of the second video clip;
in response to the second effective duration of the second video clip being greater than the first effective duration of the second video clip, cropping a part of the second video clip apart from an overlapping transition and keeping an edit starting time of the second video clip unchanged; and
in response to a second effective duration of the second video clip being equal to the first effective duration of the second video clip, keeping the second effective duration of the second video clip unchanged.

6. The method of claim 5, wherein a sum of the first effective duration, a half of a duration of a starting overlapping transition of the second video clip and a half of a duration of an ending overlapping transition duration of the second video clip is a total duration, and wherein the method further comprising:
in response to the second effective duration of the second video clip being less than the first effective duration of the second video clip, determining whether entropy of a duration of a second source video corresponding to the second video clip and comprehensive speed change is less than the total duration;
in response to the entropy of the duration of the second source video and the comprehensive speed change being greater than or equal to the total duration, cropping a clip from the second source video; and
adding the cropped clip to the second video clip.

7. The method of claim 6, wherein the second video clip includes a start editing time and an end editing time, and wherein cropping the clip from the second source video comprises:
cropping, from the second source video, a clip subsequent to the end editing time to keep the start editing time unchanged.

8. The method of claim 6, further comprising:
in response to the entropy of the duration of the second source video and the comprehensive speed change being less than the total duration, adding remaining clips in the second source video, except for the second video clip, to the second video clip;
determining whether the second video clip has an ending overlapping transition;
in response to presence of the ending overlapping transition in the second video clip, determining whether the duration of the ending overlapping transition of the second video clip is greater than a preset value; and
in response to the duration of the ending overlapping transition of the second video clip being greater than the preset value, reducing the duration of the ending overlapping transition.

9. The method of claim 8, further comprising:
in response to the duration of the ending overlapping transition of the second video clip being less than the preset value, adjusting the duration of the ending overlapping transition to the preset value; and
reducing the duration of the starting overlapping transition of the second video clip.

10. The method of claim 8, further comprising:
in response to absence of the ending overlapping transition in the second video clip, reducing the duration of the starting overlapping transition of the second video clip.

11. The method of claim 1, wherein generating the second video comprises:
in response to a sum of durations of the plurality of adjusted video clips being greater than a duration of the audio, playing a part of the video clips subsequent to an end of the audio, based on original editing effects and in a sequence of original editing order.

12. The method of claim 11, wherein generating the second video further comprises:
in response to the duration of the audio being greater than the sum of the durations of the plurality of adjusted video clips, cropping the audio, such that the duration of the audio is consistent with the sum of the durations of the plurality of adjusted video clips.

13. An electronic device, comprising:
a memory and a processor;
wherein the memory is configured to store one or more computer instructions which, when executed by the processor, cause the processor to:
determine beat point information of an audio associated with a first video;
adjust, based on the beat point information, a duration of at least one video clip among a plurality of video clips included in the first video; and
generate, based on a plurality of adjusted video clips and the audio, a second video, the second video matching the beat point information of the audio.

14. The device according to claim 13, wherein the instructions causing the processor to adjust the duration of the at least one video clip among the plurality of video clips included in the first video comprise instructions causing the processor to:
determine, based on the beat point information, a plurality of beat intervals between adjacent beat points;
determine, based on the plurality of beat intervals, a first effective duration of each video clip; and
adjust, based on the first effective duration, the duration of the at least one video clip among the plurality of video clips.

15. The device according to claim 14, wherein the instructions causing the processor to determine the first effective duration of each video clip comprise instructions causing the processor to:
for each beat interval among the plurality of beat intervals, determine a video clip corresponding to the beat interval;
determine a ratio of a duration of each video clip among the plurality of video clips to a sum of durations of the video clips; and
determine the first effective duration of each video clip among the plurality of video clips based on the ratio of each video clip among the plurality of video clips and a duration of the beat interval.

16. The device according to claim 15, wherein the video clips include a first video clip and remaining video clips, a ratio of a duration of the first video clip to the sum of the durations of the video clips is a first ratio, a maximum effective duration of the first video clip is equal to entropy of a duration of a first source video and comprehensive speed change minus a duration of a shortest overlapping transition, and wherein the instructions causing the processor to determine the first effective duration of each video clip further comprise instructions causing the processor to:
determine whether the maximum effective duration of the first video clip is less than a product of the first ratio and the duration of the beat interval;
in response to the maximum effective duration of the first video clip being less than the product of the first ratio and the duration of the beat interval, determine a first effective duration of the first video clip as the maximum effective duration;
generate a remaining duration by subtracting the maximum effective duration from the duration of the beat interval; and
determine a first effective duration of each of the remaining video clips based on a ratio of a duration of each of the remaining video clips to a sum of durations of the remaining video clips, and the remaining duration.

17. The device according to claim 14, wherein an effective time period of the video clip is a time period from a starting point of the video clip or a midpoint of a starting overlapping transition to an endpoint or a midpoint of an ending overlapping transition, the plurality of video clips include a second video clip, and wherein the instructions causing the processor to adjust the duration of the at least one video clip among the plurality of video clips comprise instructions causing the processor to:
determine whether a second effective duration of the second video clip corresponding to the effective time period is less than a first effective duration of the second video clip;
in response to the second effective duration of the second video clip being greater than the first effective duration of the second video clip, crop a part of the second video clip apart from an overlapping transition and keep an edit starting time of the second video clip unchanged; and
in response to a second effective duration of the second video clip being equal to the first effective duration of the second video clip, keep the second effective duration of the second video clip unchanged.

18. The device according to claim 17, wherein a sum of the first effective duration, a half of a duration of a starting overlapping transition of the second video clip and a half of a duration of an ending overlapping transition duration of the second video clip is a total duration, and wherein further comprises instructions causing the processor to:
in response to the second effective duration of the second video clip being less than the first effective duration of the second video clip, determine whether entropy of a duration of a second source video corresponding to the second video clip and comprehensive speed change is less than the total duration;
in response to the entropy of the duration of the second source video and the comprehensive speed change being greater than or equal to the total duration, crop a clip from the second source video; and
add the cropped clip to the second video clip.

19. The device according to claim 18, wherein the second video clip includes a start editing time and an end editing time, and wherein the instructions causing the processor to crop the clip from the second source video comprise instructions causing the processor to:
crop, from the second source video, a clip subsequent to the end editing time to keep the start editing time unchanged.

20. A non-transitory computer-readable medium comprising instructions stored thereon which, when executed by a processor, cause the processor to:
determine beat point information of an audio associated with a first video;
adjust, based on the beat point information, a duration of at least one video clip among a plurality of video clips included in the first video; and
generate, based on a plurality of adjusted video clips and the audio, a second video, the second video matching the beat point information of the audio.
